(19) United States
(12) Patent Application Publication
(10) Pub. No.: US 2024/0331421 A1
(43) Pub. Date: Oct. 3, 2024

(54) SYSTEM AND METHOD FOR ELECTRONIC SIGNATURE WITH A SMART ASSIST FEATURE FOR AUTO-SUMMARIZATION AND COMMUNICATION

(71) Applicant: Certinal Software Private Limited, Mumbai (IN)

(72) Inventor: Krishnendu Chattopadhyaya, Mumbai (IN)

(73) Assignee: Certinal Software Private Limited, Mumbai (IN)

(21) Appl. No.: 18/620,462

(22) Filed: Mar. 28, 2024

(30) Foreign Application Priority Data
Mar. 29, 2023 (IN) 202321022984

(51) Int. Cl. G06V 30/12; G06F 3/04883; G06F 16/34; G06V 30/416

(52) U.S. Cl. CPC G06V 30/127; G06F 3/04883; G06F 16/345; G06V 30/416; G06V 2201/10

(57) ABSTRACT

A system (1) and method for electronic signature comprising of an electronic signature solution (11) with a smart assist feature (11) which helps the signer (4) of the document (2) in a smart manner to verify the terms and conditions of the document (2); and wherein the smart assist feature (11) extracts and presents key metadata fields (18) from the document (2) and displays it to the signer (4) for verification; and wherein the smart assist feature (18) auto-summarizes the entire document and presents a summary to the signer; and wherein the smart assist feature (18) also allows the signer (4) to mark erroneous metadata fields in the document with a red flag (20); and wherein the smart assist feature (18) further enable the signer (4) to communicate via a message (22) to the sender (3) of the document (2), about the error in the same.

### CROSS-REFERENCE TO RELATED APPLICATION

The instant application claims priority to Indian Patent Application Serial No. 202321022984, filed Mar. 29, 2023, the entire specification of which is expressly incorporated herein by reference.

### FIELD OF THE INVENTION

The present invention relates to the field of electronic signature systems and methods. Particularly, the present invention relates to a system and method for electronic signature comprising of an electronic signature solution with a smart assist feature that auto-summarizes contractual documents to be signed, assists the signer to verify the said documents for errors and also allows the signer to communicate about the error, if any, to the sender of the document.

### BACKGROUND OF THE INVENTION

Electronic documents form an integral part of today's business world. In a business scenario, these electronic documents can be crucial documents such as agreements, contracts, tax documents, legal documents to name a few. Such documents typically require a number of people to sign them in order to be validated.

Traditionally, such important business documents were shared and exchanged between all the signatories involved in the document in order for them to sign the documents physically. This made the document exchange and signing a very cumbersome and time consuming process. In order to overcome this problem, the concept of electronic signatures was introduced a few years back. Electronic signatures make the electronic document signing process very user friendly, secure, convenient, easily accessible and less time consuming.

A few electronic signature platforms have emerged in the past few years which facilitate the process of electronic signing of the electronic documents. However, these platforms have their own limitations. For instance, in most of the electronic signature platforms currently available in the market, the contractual documents (contracts) are provided by the sender to the signer for signing. Before signing such important documents, the signer needs to verify them and read through the entire documents for any kind of errors, especially in the terms and conditions of the contract. This reading needs to be done manually, which makes the assessment of documents a very time consuming process and error prone.

In addition to the above, currently there are no electronic signature platforms available which assist the signer to assess the terms and conditions of the documents (contracts) and to check if all the essential terms and conditions are correct or not. There are no platforms which assist the signer in this verification process. Furthermore, the existing electronic signature platforms in the market do not facilitate any kind of interaction and/or communication between the signer and the sender with respect to the erroneous contents in the document(s) to be signed. The above listed drawbacks of the existing platforms hamper their utility, efficiency and user-friendliness.

### PRIOR ART

US Patent Publication No. 20160239471 describes a system, computer-readable storage medium, and computer-implemented method for improved document signing involving generating secure document copies of a document to be signed in response to receiving actions to perform on the document. In particular, a web service can transmit a document for signing to a plurality of client devices such that the document is viewable through a graphical user interface while the underlying content of the document remains non-editable. Responsive to receiving actions from different client devices, secure document copies of the document can be generated that include additional content form the different client devices. However, the patent does not disclose anything about a provision to auto-summarize the document to allow the client to verify it in a smart manner, nor does it specify about any specific feature which enables communication between the sender and the signer if there is any error in the document.

Hence, there is a need for a system and a method which primarily addresses the limitations discussed above and provides a technical solution to the above problems.

### OBJECTS OF THE INVENTION

An object of the present invention is to provide a system and method for electronic signatures comprising of a smart-assist feature.

Yet another object of the present invention is to provide a system and method for electronic signatures wherein the smart-assist feature assists the signer to verify the terms and conditions of the documents (contracts) and to check if all the essential terms and conditions are correct or not.

Yet another object of the present invention is to provide a system and method for electronic signatures wherein the smart-assist feature extracts essential/key metadata fields from the documents and displays them to the signer for verification.

Yet another object of the present invention is to provide a system and method for electronic signatures with the smart-assist feature, wherein the essential/key metadata fields to be extracted are configurable by the sender of the document.

Yet another object of the present invention is to provide a system and method for electronic signatures wherein the smart-assist feature allows relevant metadata fields for individual paragraphs in the document to keep appearing as the signer scrolls down the document.

Yet another object of the present invention is to provide a system and method for electronic signatures wherein the smart-assist feature automatically displays a summary of all the essential meta data fields of the document.

Yet another object of the present invention is to provide a system and method for electronic signatures wherein the smart-assist feature allows the signer to mark specific erroneous metadata fields with a red flag.

Yet another object of the present invention is to provide a system and method for electronic signatures wherein the smart-assist feature enables the signer to communicate regarding the erroneous metadata fields to the sender of the document.

Yet another object of the present invention is to provide a system and method for electronic signatures wherein the smart-assist feature allows sending of the message from the signer as well as the document back to the sender for correction of the errors.

Yet another object of the present invention is to provide a system and method which is highly time saving, user friendly and efficient.

### SUMMARY OF THE INVENTION

The present invention relates to a system and method for electronic signature which comprises of an electronic signature solution with a smart assist feature, helping and assisting the signer of the document on various aspects. Particularly, the present invention relates to a system and method for electronic signature comprising of a smart assist feature that auto-summarizes contractual documents to be signed, assists the signer to verify the said documents for errors and also allows the signer to communicate about the error, if any, to the sender of the document.

In one aspect, the system of the present invention comprises of a document to be signed, a sender of the document, a signer of the document, a sender computing system, a signer computing system, a communication network, a hosting server, plurality of databases, and an electronic signature solution with a smart assist feature and a graphical user interface. These structural components of the system act in a coordinated manner with each other so as assist the sender with the verification of document(s) received from sender.

In another aspect, the smart assist feature of the system allows the signer of the document to verify the contents of a document received for signing. The smart assist feature extracts key metadata fields from individual paragraphs of the documents and automatically, smartly and instantaneously displays the corresponding key metadata fields for the individual paragraphs of the document to the signer as he scrolls down the document for verification. The smart assist feature further assists the signer of the document by auto-summarizing the key metadata fields in the document and displaying the summary to the signer of the document in an intelligent manner.

In yet another aspect, the smart assist feature of the system allows the signer to mark the erroneous metadata fields of the received document with red flags. The signer is further enabled by the smart assist feature to type a message at relevant locations and communicate it to the sender. The document is then sent back to the sender for corrections, along with the message.

In yet another aspect, the method of the present invention involves steps such as sending, transmitting, receiving and accessing of the document to be signed. The method further includes extraction of key metadata fields and display to the signer. If an error is located in the document, the method further enables the signer to mark the erroneous metadata fields with a red flag and communicate a message about the error to the sender of the document and send back the document to him for correction.

### BRIEF DESCRIPTION OF THE DRAWINGS

FIG. 1 illustrates a schematic view of the system of the present invention.

FIG. 2 illustrates a schematic view of the computing system of the sender and the signer.

FIG. 3 illustrates a schematic view of a series of steps performed at the signer's end when an error is detected in the document to be signed.

FIG. 4 illustrates a schematic view of a series of steps marking the incorrect metadata fields with a red flag and communication of the flagged document and message to the sender.

FIG. 5 illustrates a schematic view of the workflow of the method of the present invention.

### DETAILED DESCRIPTION OF THE INVENTION

### Definitions

Metadata field: Metadata field in context of the present invention refers to a key or essential field in the document (contract) to be signed [e.g., term of a contract, date of execution etc.]. The term metadata generally relates to a set of data which describes and provides information about some other kind of data.

Before the present invention is described, it is to be understood that this invention is not limited to methodologies described, as these may vary as per the person skilled in the art. It is also to be understood that the terminology used in the description is for the purpose of describing the particular embodiments only and is not intended to limit the scope of the present invention. Throughout this specification, the word “comprise,” or variations such as “comprises” or “comprising,” will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

The present invention relates to a system and method for electronic signature comprising of a smart assist feature that auto-summarizes contractual documents to be signed, assists the signer to verify the said documents for errors and also allows the signer to communicate about the error, if any, to the sender of the document.

In an embodiment, the system (1) for electronic signature with a smart assist feature comprises of a document (2) to be signed, a sender (3) of the document, a signer (4) of the document, a sender computing system (5), a signer computing system (6), a communication network (7), a hosting server (8), plurality of databases (9), and an electronic signature solution (10) with a smart assist feature (11) and a graphical user interface (12).

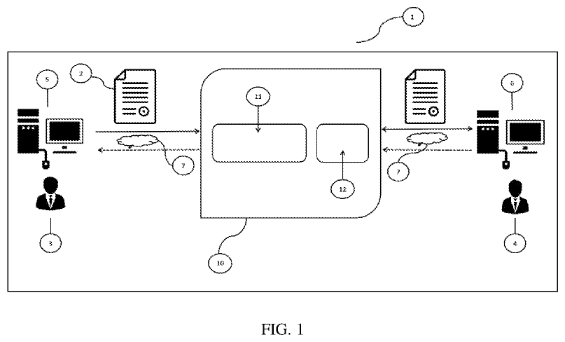

In an embodiment, the sender computing system (5) and the signer computing system (6) each comprise of a memory unit (13) capable of storing instructions which when followed lead to performance of certain computational steps, a processing means (14), input devices (15), output devices (16), a network connection means (17) capable of connecting to the communication network (7), and plurality of databases (9). The memory unit (13) further comprises of an electronic signature solution (10) with a smart assist feature (11). The overall schematic of the system (1) is depicted in FIG. 1.

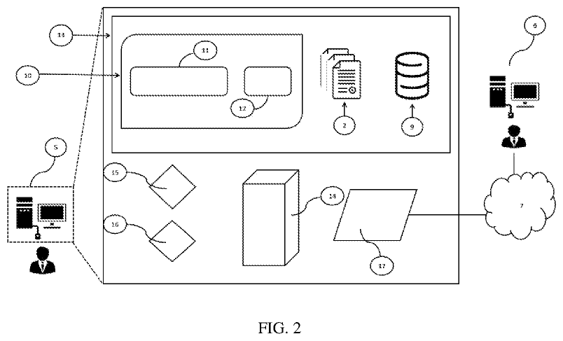

In an embodiment (e.g., see FIG. 2), the sender (3), via his/her computing system (5) sends the document (2) to be signed to the signer (4) by means of the electronic signature solution (10) with a smart assist feature (11). The document (2) may be of any nature, but is typically a contract to be signed by the signer (4). The present invention is described by way of considering the document (2) to be a contract only by explanatory purposes and by no way should limit the scope of the invention to only such kind of documents. The document (2) is transmitted to the signer (4) via the communication network (7). The sender (3), as well as the signer (4), is enabled to interact with the electronic signature solution (10) through the graphical user interface (12) and by using the input devices (15) and output devices (16) of their respective computing systems.

In an embodiment, when the signer (4) receives the document (2) on his computing device (6), he is enabled to avail the smart assist feature (11) of the electronic signature solution (10). Once the signer clicks on the smart assist feature (11) of the electronic signature solution (10), he is assisted on various fronts by the smart assist feature (11) as described below.

In a preferred embodiment, the smart assist feature (11) extracts the key metadata fields (18) related to each paragraph (19) of the document (2). The extraction of the key metadata fields (18) is dependent on pre-configured training of the electronic signature solution (10). The key metadata fields (18) include but are not limited to names of the parties to the contract, term of contract, date of execution of contract, date of expiry of the contract, value of contract, renewal term, termination option, penalty amount, liquidated damages amount, limitation of liability, credit period, price escalation percentage, termination for convenience, termination for breach, and force majeure. The key metadata fields would vary depending on the nature of the document to be signed. The extracted key metadata fields (18) are displayed to the signer (4) by means of the graphical user interface (12) for verification. The key metadata fields (18) which can be extracted and displayed to the signer (4) are configurable by the sender (3). In an embodiment, the electronic signature solution includes databases which contain heuristic learnings for extraction of key metadata fields (18) from the document (2).

In a preferred embodiment involving the smart assist feature, when the signer (4) scrolls down the document (2), the corresponding key metadata fields (18) for respective paragraphs (19) being displayed instantaneously to the signer (4) are also presented at the same time in an automatic and smart manner. This automatic and smart presentation of the key metadata fields (18) avoids the time consuming process of checking all the contents and/or terms and conditions of the document (2) manually by the signer (4). Furthermore, when the signer (4) reaches the end of the document (2), the smart assist feature (11) also summarizes the entire document (2) in terms of a compilation of all the key metadata fields (18). This smartly assists the signer by presenting the most important information of the document at a glance, in a concise manner thereby making the electronic signature solution (10) very convenient and user friendly. In an alternate embodiment, the signer (4) can also view the summary of the document (2) at any point of time by clicking on a separate tab related to summary available on the graphical user interface (12).

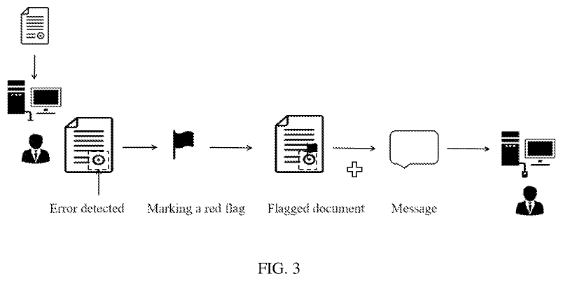

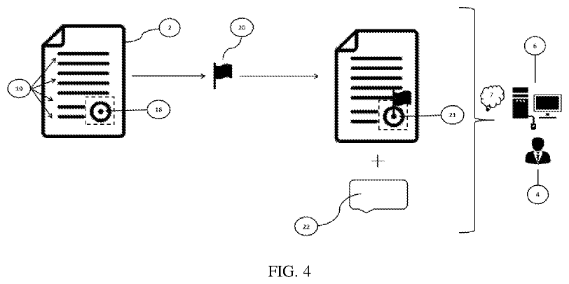

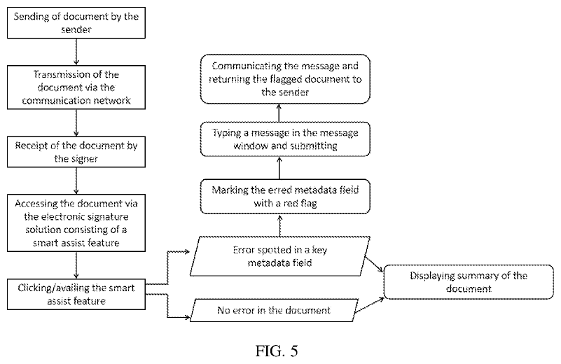

In a preferred embodiment (e.g., see FIG. 3) if the signer (4), while scrolling down the document and viewing the key metadata fields (18) presented to him, finds an error in any of them, a further workflow comes into picture as depicted in FIGS. 4 and 5. In such a case, the smart assist feature (11) enables the signer (4) to mark that particular metadata field (18) with a red flag (20). The signer (4) can click on the incorrect or erred key metadata field (21) and mark it with a red flag (20). For example, if the signer (4) notices that the metadata field (18) of “term of contract” in the document (2) received from the sender (3) is 3 years, and if the parties had previously agreed on a period of only 2 years, the signer (4) can mark the “term of contract” field with a red flag (20) to indicate the error.

In a preferred embodiment, when the signer (4) marks any key metadata field with a red flag (20), a message window pops up and he is enabled to type a message (22) in it. The signer (4) can type his message (22) with respect to the error that needs to be corrected and submit it. For example, a message “the term of contract” should be corrected to 2 years from 3 years can be typed out and submitted by the signer in light of the above illustration. The submitted message (22) as well as the document (2) that now needs to be corrected is returned to the sender (3) via the communication network (7). Thus, this aspect of the smart assist feature (11) enables the signer (4) to communicate with the sender (3) about the incorrect terms and conditions or any other errors in the document (2).

In an embodiment, the method for electronic signature with a smart assist feature (11) comprises the following steps which are also depicted in FIG. 5:
sending of the document (2) to be signed by the sender (3) to the signer (4) from the sender computing system (5);
transmission of the document (2) via a communication network (7);
receiving the transmitted document (2) by the signer (4) on the signer computing device (6);
accessing the transmitted document (2) via the electronic signature solution (10) comprising of the smart assist feature (11);
clicking on the smart assist feature (11);
performance of the following steps by the smart assist feature (11);
extraction of key metadata fields (18) from individual paragraphs (19);
automatic display/presentation of the key metadata fields from individual paragraphs (19) in an instantaneous and smart manner as the signer scrolls down the document (2) for verification;
execution of the following steps in case of an error in any of the key metadata fields (18) of the document;
marking the erred metadata fields (21) with a red flag (20) by the signer;
popping up of a message window to the signer (4);
typing of a message (22) by the signer (4), to be communicated to the sender (3);
returning the flagged document (2) and communicating the message (22) to the sender (3) via the communication network; and
automated displaying of summary of all the key metadata fields (18) of the document (2) to the signer (4).

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A system for electronic signature having at least one document to be signed, a sender computing system, a signer computing system, a communication network, a hosting server to store the document, an input device, an output device, and plurality of databases, comprising:
an electronic signature solution including a smart assist feature and a graphical user interface;
wherein the smart assist feature assists the signer to assess the document for errors;
wherein the smart assist feature extracts the key metadata fields from individual paragraphs of the document;
wherein the electronic signature solution includes databases which contain heuristic learnings for extraction of key metadata fields from the document;
wherein the smart assist feature automatically, instantaneously and smartly displays the corresponding key metadata fields for the individual paragraphs of the document to the signer as he scrolls down the document for verification;
wherein the smart assist feature enables the signer to mark incorrect key metadata fields, if any, with a red flag;
wherein the smart assist feature enables the signer to type a message with respect to an erred metadata field, to be communicated to the sender;
wherein the electronic signature solution allows communication of the message and returning of the document for correction to the sender via the communication network;
wherein the smart assist feature automatically and smartly displays a summary of the document consisting of compilation of all key metadata fields; and
wherein the sender and the signer interact with the electronic signature solution) through the graphical user interface.

2. The system as claimed in claim 1, wherein the sender computing system and the signer computing system communicate with each other via the communication network.

3. The system as claimed in claim 1, wherein the key metadata fields include names of the parties to the contract, term of contract, date of execution of contract, date of expiry of the contract, value of contract, renewal term, termination option, penalty amount, liquidated damages amount, limitation of liability, credit period, price escalation percentage, termination for convenience, termination for breach, and force majeure.

4. The system as claimed in claim 1, wherein the smart assist feature extracts the key metadata fields based on pre-configured training of the electronic signature solution.

5. The system as claimed in claim 1, wherein the key metadata fields to be displayed to the signer are configurable by the sender.

6. A method for electronic signature including an electronic signature solution with a smart assist feature, comprising the steps of:
sending of at least one document to be signed by a sender to a signer from a sender computing system;
transmission of the document via a communication network;
receiving the transmitted document by the signer on a signer computing device;
accessing the transmitted document via the electronic signature solution comprising of the smart assist feature;
clicking on the smart assist feature;
performance of the following steps by the smart assist feature;
extraction of key metadata fields from individual paragraphs;
automatic display/presentation of the key metadata fields from individual paragraphs in an instantaneous and smart manner as the signer scrolls down the document for verification; and
execution of the following steps in case of an error in any of the key metadata fields of the document:
marking the erred metadata fields with a red flag by the signer;
popping up of a message window to the signer;
typing of a message by the signer, to be communicated to the sender;
returning the flagged document and communicating the message to the sender via the communication network; and
automated displaying of summary of all the key metadata fields of the document to the signer.
